(19) United States
(12) Patent Application Publication
(10) Pub. No.: US 2013/0004623 A1
(43) Pub. Date: Jan. 3, 2013

(54) METHOD OF PRODUCING NOT-HARDENED WAXY RICE CAKE AND WAXY RICE CAKE PRODUCED BY USING THE SAME

(75) Inventors: Hye Young Park, Seoul (KR); Gwi Jung Han, Ansan-si (KR); Soo Hwan Yeo, Suwon-si (KR); Hye Sun Choi, Hwaseong-si (KR); Seong Yeol Baek, Suwon-si (KR); Dong Sun Shin, Hwaseong-si (KR)

(73) Assignee: REPUBLIC OF KOREA (MANAGEMENT :RURAL DEVELOPMENT ADMINISTRATION), Suwon (KR)

(21) Appl. No.: 13/500,074

(22) PCT Filed: Dec. 22, 2011
(86) PCT No.: PCT/KR2011/009982

§ 371 Date: Apr. 4, 2012

(30) Foreign Application Priority Data
Jun. 30, 2011 (KR) 10-2011-0065190

(51) Int. Cl. A23L 1/10; A21D 13/00

(52) U.S. Cl. 426/94; 426/497; 426/560

(57) ABSTRACT

Provided are a method of producing a waxy rice cake that is not hardened for shelf-life, including: (a) immersing waxy rice in water and removing the water therefrom; (b) first steaming the waxy rice from which water is removed; (c) adding salt and water to the first steamed waxy rice, followed by second steaming; and (d) cooling the second steamed waxy rice and adding flour thereto, followed by punching, a waxy rice cake produced by using the method, and a processed food produced by processing the waxy rice cake. The waxy rice cake has longer storage duration than a conventional waxy rice cake and due to the long storage duration, the waxy rice cake can be distributed for shelf-life according to storage conditions. Also, the waxy rice cake retains its chewy texture and thus is suitable for consumers' tastes.

### TECHNICAL FIELD

The present invention relates to a method of producing a waxy rice cake that is not hardened for shelf-life, in which the method includes: (a) immersing waxy rice in water and removing the water therefrom; (b) first steaming the waxy rice from which water is removed; (c) adding salt and water to the first steamed waxy rice, followed by second steaming; and (d) cooling the second steamed waxy rice and adding flour thereto, followed by punching, a waxy rice cake produced by using the method, and a processed food produced by processing the waxy rice cake.

### BACKGROUND ART

Rice can be categorized as non-waxy rice and waxy rice according to transparency, and non-waxy rice is transparent and waxy rice is milky and non-transparent. Starch, which is a major component of rice, consists of amylose and amylopectin which are polysaccharides. Waxy rice mainly consists of amylopectin, and non-waxy rice consists of 15 to 20% of amylose and 80 to 85% amylopectin. Accordingly, when waxy rice is cooked or processed to produce rice cake, the waxy rice is much stickier than the non-waxy rice. Due to such a big difference in starch tissue between non-waxy rice and waxy rice, even when they are processed using the same method, they are used for different purposes and qualities of their processed products are very different from each other.

Retrogradation of starch refers to a phenomenon in which when gelatinized starch is left at room temperature for a long period of time, starch molecules are combined with each other through a hydrogen bond, thereby forming a crystal structure locally. Due to the formation of hydrogen bond in starch, water present in starch is released out and thus, a product is hardened. The retrogradation of starch is affected by, for example, physical and chemical conditions and various additives, such as the kind of starch, a ratio of amylose to amylopectin in starch, a storage temperature, a pH, and a water content. Many efforts have been made to suppress retrogradation of starch by using trehalose, a surfactant, an emulsifier, an oligosaccharide, or an amylase for saccharifing fresh starch. However, most conventional retrogradation suppression methods use an additive, a preservative, etc. Accordingly, there is still a need to develop a rice cake that has good texture without use of food additives and that has a long storage time to enable the rice cake to be not hardened at room temperature for shelf-life.

### DISCLOSURE OF INVENTION

### Technical Problem

Provided is a waxy rice cake that is prepared by controlling various factors in producing the waxy rice cake to minimize hardness thereof during storage. Accordingly, unlike a waxy rice cake that is produced using a typical method and is thereby hardened after a predetermined time period after its production, the waxy rice cake according to the present invention retains its springiness property and thus long-term distribution thereof is possible according to storage conditions. Also, the waxy rice cake is suitable for consumers' tastes due to its not-hardening texture for shelf-life.

### Solution to Problem

According to an aspect of the present invention, a method of producing a waxy rice cake that is not hardened for shelf-life includes: (a) immersing waxy rice in water and removing the water therefrom; (b) first steaming the waxy rice from which water is removed; (c) adding salt and water to the first steamed waxy rice, followed by second steaming; and (d) cooling the second steamed waxy rice and adding flour thereto, followed by punching.

According to another aspect of the present invention, a waxy rice cake produced by using the method is provided.

According to another aspect of the present invention, a processed food produced by processing the waxy rice cake is provided.

### Advantageous Effects of Invention

A waxy rice cake according to the present invention retains its humid and springy texture for a longer period of time than a typical rice cake by suppressing retrogradation without use of additives, and also because food additives are not used, the waxy rice cake is suitable for consumers' tastes.

In addition, due to its long-term non-hardening property, the waxy rice cake according to the present invention can be stored for shelf-life, which enables mass-production and long-term distribution according to storage conditions. Furthermore, the waxy rice cake may lead to increasing rice consumption in Korea and may catalyze development of export products for globalization of Korean food.

### BRIEF DESCRIPTION OF DRAWINGS

FIG. 1 shows a waxy rice cake production method according to an embodiment of the present invention and a typical waxy rice cake production method.

FIG. 2 shows pictures showing a method of producing a waxy rice cake according to an embodiment of the present invention.

FIG. 3 shows a texture change during storage according to a flour content in Injeolmi (Korean traditional rice cake made from waxy rice and coated with bean flour) when extruding was further performed.

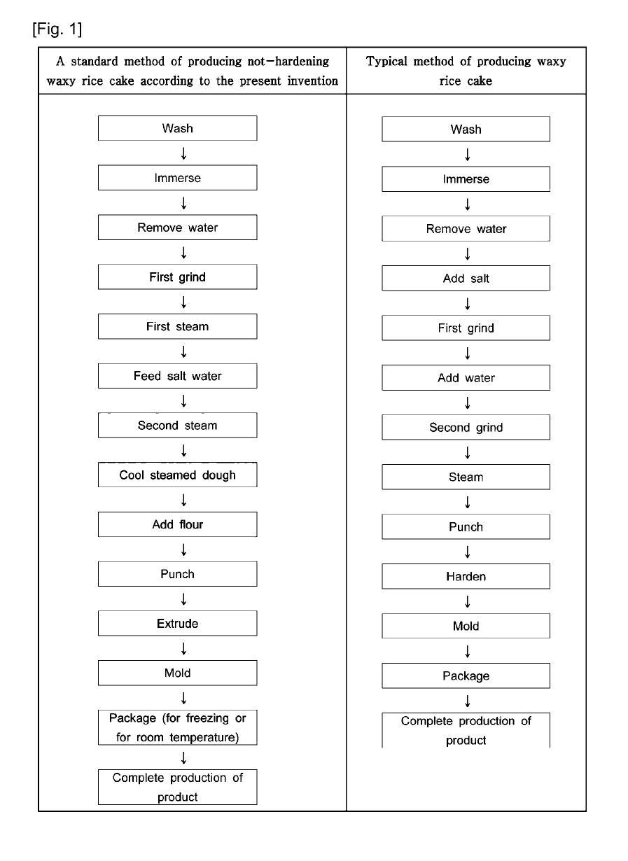

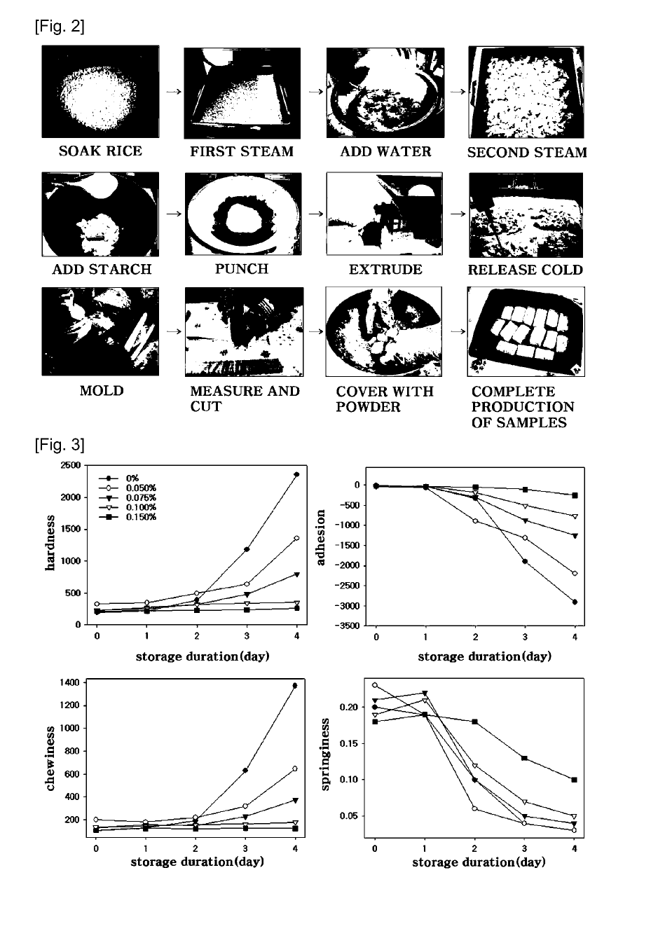

### BEST MODE FOR CARRYING OUT THE INVENTION

A method of producing a waxy rice cake that is not hardened for shelf-life according to an embodiment of the present invention includes:

(a) immersing waxy rice in water and removing the water therefrom;

(b) first steaming the waxy rice from which water is removed;

(c) adding salt and water to the first steamed waxy rice, followed by second steaming; and

(d) cooling the second steamed waxy rice and adding flour thereto, followed by punching.

Like a typical rice cake production method, in the initial phase, the method of producing waxy rice cake according to the present embodiment includes immersing waxy rice in water and removing the water therefrom. The immersing in water is a process for allowing grains of waxy rice to sufficiently absorb water. The immersing time may be in a range of 3 to 14 hours, and for example, 4 to 8 hours. Thereafter, the immersed waxy rice undergoes the water removal process for 10 to 60 minutes, and for example, 20 to 40 minutes to remove water present among the grains of waxy rice.

The method may further include grinding the water-removed waxy rice by using a grinder before the first steaming. Due to the grinding of waxy rice, a frequency of grains of waxy rice dispersed randomly in completed rice cake may be reduced. For the grinding, according to the kind of a desired rice cake, a roller size of a grinder and the count of grinding may be controlled to obtain a desired grinding product. For example, to make Injeolmi, grinding may be performed once or two times by using a grinder having a roller interval of 2 to 4 mm. In an embodiment of the present invention, the water-removed waxy rice may be ground once by using a grinder having a roller interval of 3 mm. If the waxy rice is ground at a roller interval of less than 2 mm, waxy rice is too sticky and thus, when flour is added into a formed dough, the adding may not be appropriately performed. If the waxy rice is ground at a roller interval of greater than 4 mm, the waxy rice may not be gelatinized well during steaming and grains of rice remain in a formed rice cake.

The ground waxy rice may be first steamed at a high temperature of 85 to 100° C. A first steaming time may vary according to the kind of a desired rice cake. Typically, the first steaming time may be in a range of 15 to 60 minutes, and for example, 20 to 40 minutes. If the first steaming time is shorter than 15 minutes, a rice cake may not be sufficiently steamed after steam rising. On the other hand, if the first steaming time is longer than 60 minutes, the dough after the steaming may be watery.

The first-steamed waxy rice is second-steamed after a salt water is added thereto. According to the present invention, the salt water in process (c) may be prepared by mixing 2 to 20 wt % of water and 0.75 to 1.8 wt % of salt based on the waxy rice from which water is removed in process (a). For example, the salt water may be prepared by mixing 4 to 15 wt % of water and 0.8 to 1.5 wt % of salt. The salt water is used to produce a waxy rice cake that has distinct color and better taste and to prevent proliferation of microorganisms and corruption in the formed waxy rice cake. Herein, the kind of salt is not limited. Also, if the amount of water added to the salt water is less than 2 wt %, rice cake is rapidly hardened and thus the hardening prevention effect is low and the chewy texture may deteriorate. On the other hand, if the amount of water is greater than 20 wt %, a formed rice cake has low viscosity and poor springiness and thus a formed waxy rice cake does not have a desired level of quality.

The waxy rice to which the salt water is added may be second-steamed at a high temperature of 85 to 100° C. A second steaming time may vary according to the kind of a desired rice cake. Typically, the second steaming time may be in a range of 5 to 45 minutes, and for example, 10 to 30 minutes. If the second steaming time is within the ranges described above, a formed dough is not watery and thus the waxy rice is sufficiently gelatinized.

According to the present invention, the second-steamed waxy rice may be cooled until an inner temperature of the waxy rice dough at room temperature is in a range of 51 to 79° C., and for example, 61 to 69. If the inner temperature of the waxy rice dough during cooling after the waxy rice is second-steamed is less than 51° C., the dough may be completely cooled during the punching after the cooling and thus, the efficiency of a subsequent process may be low. On the other hand, if the inner temperature of the waxy rice is higher than 79° C., after a predetermined period of time (for example, 24 hours) has passed, a hardness of the waxy rice cake may be increased to a level that is not appropriate for the prevention of hardening the waxy rice cake.

According to the present invention, to prepare a waxy rice cake that is not hardened for shelf-life, flour is added after the waxy rice is cooled. The flour used in the present invention may be high protein flour, medium protein flour, or low protein flour and may not be limited thereto. A flour content added may be in a range of 0.08 to 1.0 wt %, and for example, 0.1 to 0.7 wt %, based on the waxy rice from which water is removed in process (a), according to storage or distribution conditions of a completed product. For example, if a formed rice cake is distributed at room temperature after production, the flour content may be in a range of 0.08 to 0.5 wt %, and for example, 0.1 to 0.45 wt %. For example, if a formed rice cake is distributed in a frozen form, the flour content may be in a range of 0.51 to 1.0 wt %, and for example, 0.55 to 0.7 wt %. If the flour contents are lower than the respective lower limits in each case, after a predetermined time period (for example, 24 hours) has passed, a hardness of the waxy rice cake may be increased to a level that is not appropriate for the prevention of hardening the waxy rice cake. On the other hand, if the flour contents are higher than the respective higher limits in each case, tastes may be lowered in terms of sensory characteristics although the hardness is lowered.

After the flour is added, punching is performed to homogeneously mix the waxy rice dough with the flour and to provide the dough texture with particular properties such as adhesiveness or cohesiveness. In the present embodiment, the punching time may be in a range of 3 to 20 minutes, and for example, 7 to 15 minutes. The punching time may be dependent upon a rotational number or a power number of a punching device. Also, if the punching time is less than 3 minutes, the flour may not be homogeneously mixed with the dough and thus hardening may not be prevented. On the other hand, if the punching time is longer than 20 minutes, a formed waxy rice cake may have too tough and thus, a quality of the final product may be degraded.

The method may further include extruding the punched waxy rice cake to mold the steamed and punched waxy rice cake dough into a desired shape. During the extruding, the punched waxy rice dough is passed once through a bar rice cake molder and due to a strong pressure applied by an inner screw of the bar rice cake molder, grains of rice in the dough are ground and a product quality is improved.

The present invention also provides a waxy rice cake that is not hardened for shelf-life. The waxy rice cake according to the present invention has a small texture change even after shelf-life has passed and has excellent sensory characteristics. Also, a waxy rice cake produced by using the method according to the present invention may be Injeolmi (mugwort Injeolmi, marriage Injeolmi, red bean Injeolmi), but is not limited thereto. For example, the waxy rice cake may be a flower Injeolmi, a glutinous millet Injeolmi, a small straw bag-shaped rice cake, a cake flavored with pine endodermis, a sticky nutrient rice cake, Danja (small waxy rice dough filled with a mixture of honey and chestnut, sesame, or the like and coated with honey and various grain powder), or the like.

The present invention also provides a processed food of the waxy rice cake. The processed food may be an egg-shaped dumpling formed of rice cake, a fusion rice cake, a chocolate waxy rice cake, a waxy rice iced sandwich (ice cream), a sticky snack (waxy rice cake sandwich snack), a waxy rice cake for ice flakes with syrup, or a waxy rice cake for salad, but is not limited thereto.

Hereinafter, embodiments of the present invention will be described in detail. However, the embodiments are provided for illustrative purpose only and the present invention is not limited to the embodiments.

Test Materials

A waxy rice used in the following experiments was rice that was harvested in Korea and polished in 2010, and flour (DAEHAN FLOUR MILLS Co., Ltd), salt (SAJOHAPYO Co., Ltd), and bean powder (Yeong Wol Processing Business Office of National Agricultural Cooperative Federation) were used in producing a waxy rice cake.

### Preparation Example 1

### Production of Injeolmi with Different Water Contents

Injeolmi was produced using blending ratios and methods shown in Table 1 while the water content, which is a key factor in producing Injeolmi, was changed to be 0, 5, 10, 15, and 20% based on the weight of a water-soaked waxy rice. That is, waxy rice was immersed in water for 4 to 8 hours and water was removed therefrom, and a weight of the water-soaked waxy rice was measured, and the waxy rice was first steamed using an earthenware-steamer type steam boiler (Kyungchang Machine, Kyunggi Kwangjoo, Korea) for 20 to 40 minutes. In each case, 0.8 to 1.5 wt % of salt based on the weight of the soaked waxy rice was added to water in a corresponding amount shown in Table 1 to prepare a salt water, and then the salt water was added to the first-steam waxy rice, followed by second steaming for 10 to 30 minutes. The second-steamed product was cooled at room temperature until an inner temperature of the steamed dough reached 61 to 69° C. The cooled waxy rice dough was placed on a punching device and 0.1 to 0.7% of flour based on the weight of the soaked waxy rice was added thereto according to storage conditions or distribution conditions, followed by punching for 7 to 15 minutes. The punched dough was uniformly spread using a rolling rod until the dough has an even flat surface. Then, the dough was cut to a size of a height of 1.5 cm, a distance of 3 cm, and a width of 2 cm and the cut dough was molded. The obtained product was covered with bean powder and packaged with a wrap and stored at room temperature. The product was used in the following experiments.

TABLE 1
Blending ratios and methods of Injeolmi at different water contents

| | Water content based on the | | | | |
|---|---|---|---|---|---|
| Material and | weight of water-soaked waxy rice (%) | | | | |
| method | 0 | 5 | 10 | 15 | 20 |
| water-soaked | 3,000 | 3,000 | 3,000 | 3,000 | 3,000 |
| waxy rice (g) | | | | | |
| Salt (g) | 30 | 30 | 30 | 30 | 30 |
| Water (ml) | 0 | 150 | 300 | 450 | 600 |
| Flour (g) | 6 | 6 | 6 | 6 | 6 |
| Punching | 13 | 13 | 13 | 13 | 13 |
| (minutes) | | | | | |

### Preparation Example 2

### Production of Injeolmi with Different Flour Contents

Blending ratios and methods of Injeolmi prepared using different flour contents are shown in Table 2 below. The flour content is a key factor during the punching in the course of production of Injeolmi. Injeolmi was prepared in the same manner as in Preparation Example 1, except that the water content was 5% or 10% based on the weight of the water-soaked waxy rice and the flour content was 0, 0.05, 0.1, 0.15, and 0.2% based on the weight of the water-soaked waxy rice.

TABLE 2
Blending ratios and methods of Injeolmi at different flour contents

| | Flour content based on the weight | | | | |
|---|---|---|---|---|---|
| Material and | of the water-soaked waxy rice (%) | | | | |
| method | 0 | 0.05 | 0.1 | 0.15 | 0.2 |
| Water- | 3,000 | 3,000 | 3,000 | 3,000 | 3,000 |
| soaked | | | | | |
| waxy rice (g) | | | | | |
| Salt (g) | 30 | 30 | 30 | 30 | 30 |
| Water (ml) | 150 or 300 | 150 or 300 | 150 or 300 | 150 or 300 | 150 or 300 |
| Flour (g) | 0 | 1.5 | 3 | 4.5 | 6 |
| Punching | 13 | 13 | 13 | 13 | 13 |
| (minutes) | | | | | |

### Preparation Example 3

### Production of Injeolmi when Extruding was Further Performed

The method of producing Injeolmi further included extruding after the punching. In detail, Injeolmi was produced in the same manner as in Preparation Example 1, except that the water content was 5% based on the weight of the water-soaked waxy rice, and the flour content was 0, 0.05, 0.075, 0.1, and 0.15% based on the weight of the water-soaked waxy rice. The extruding was performed by extruding the punched waxy rice dough by using a bar rice cake molder. The extruding minimized grains of waxy rice that were not squashed in the waxy rice dough and smoothened the waxy rice dough.

### Preparation Example 4

### Production of Frozen Injeolmi with Different Flour Contents

Typically, a rice cake is consumed immediately after purchase due to retrogradation of starch. Currently, all kinds of rice cakes are produced and sold on the same day, except for dry rice cake. To improve distribution efficiency, a method of producing waxy rice of which quality is not degraded even under freezing or cold conditions is needed. For this, herein, whether properties of Injeolmi are recovered to its original states after Injeolmi was frozen and thawed and whether the recovered properties are sustainable, was evaluated.

Blending ratios and methods of frozen Injeolmi prepared using different flour contents are shown in Table 3 below. The flour content is a key factor during the punching in the course of production of frozen Injeolmi. That is, frozen Injeolmi was produced in the same manner as in Preparation Example 3, except that the flour content was 0.5, and 0.7% based on the weight of the water-soaked waxy rice and a produced Injeolmi was frozen and stored at a temperature of 4° C. and 20° C. and thawed.

TABLE 3
Blending ratios and methods of frozen Injeolmi at different flour contents

| | |
|---|---|
| | Flour content based on the weight |
| Material and | of the water-soaked waxy rice (%) |

| method | 0.5 | 0.7 |
|---|---|---|
| Water-soaked | 3,000 | 3,000 |
| waxy rice (g) | | |
| Salt (g) | 30 | 30 |
| Water (ml) | 150 | 150 |
| Flour (g) | 15 | 21 |
| Punching | 13 | 13 |
| (minutes) | | |

### Preparation Example 5

### Production of Frozen Injeolmi when Grinding was Further Performed

The method of producing frozen Injeolmi further included grinding. In detail, Injeolmi was produced in the same manner as in Preparation Example 4, except that the water-soaked waxy rice was ground using a roll grinder (KM18, Kyungchang Machine, Kyunggi Kwangjoo, Korea) while a roll interval was adjusted to be 3 mm and then the ground waxy rice was first-steamed.

Injeolmi Texture Evaluation

To measure properties of Injeolmi prepared according to Preparation Examples 1-5, each Injeolmi was prepared as a rectangular sample (distance of 3 cm×width of 2 cm×height of 1.5 cm). A 2nd bite compression test was performed on each of the samples by using a texture analyzer (TA-XT2, Stable Micro System Ltd., Haslemere, UK) and texture profile analysis (TPA). The 2nd bite compression test was performed ten times for each. The test conditions included a pre-test speed of 5 mm/s, a test speed of 3 mm/s, a post-test speed of 5 mm/s, and a stain of 80%. From a obtained force-distance curve, TPA characteristics, such as hardness, adhesivenss, springiness, cohesiveness, gumminess, or chewiness, were analyzed using texture expert software.

### Example 1

### Injeolmi Texture Change According to Different Water Contents

Preliminary tests were performed to determine water content. As a result, when the water content was 20 wt % based on the weight of the water-soaked waxy rice, a obtained dough was too watery and thus was not appropriate for production of Injeolmi. Accordingly, the water content in Injeolmi was determined as 0, 5, 10, 15, and 20 wt %, and texture change of waxy rice according to storage duration at different water contents was evaluated and results thereof are shown in Table 4.

As a result, the higher the water content, the Injeolmi had smaller hardness. In the case of a group to which water was not added, the hardness was increased the most during storage. The increase in hardness of rice cake occurs due to retrogradation of starch, and it was confirmed that the higher water content results in the slower retrogradation speed of starch. In terms of springiness and cohesiveness, the respective groups have similar characteristics. However, as the water content increased, adhesion, gumminess, and chewiness were decreased. Accordingly, although the higher water content lead to slower retrogradation of rice cake, springiness, chewiness, and product quality of Injeolmi were substantially decreased. Thus, it was confirmed that a water content that is suitable for producing high-quality Injeolmi that delays retrogradation of rice cake while retaining an appropriate texture was 4 to 15 wt %.

TABLE 4
Texture analysis according to water content when Injeolmi was stored at a temperature of 20° C.

| Water content | Storage duration | | | | | | |
|---|---|---|---|---|---|---|---|
| (%) | (day) | Hardness | Adhesion | Springiness | Cohesiveness | Gumminess | Chewiness |
| 0 | 0 | 242 | −28 | 0.87 | 0.70 | 170 | 147 |
| | 1 | 690 | −637 | 0.93 | 0.49 | 337 | 313 |
| | 2 | 1162 | −2016 | 0.98 | 0.51 | 593 | 579 |
| | 3 | 1626 | −2347 | 1.00 | 0.52 | 847 | 846 |
| | 4 | 1842 | −3192 | 0.99 | 0.51 | 941 | 931 |
| 5 | 0 | 264 | −20 | 0.88 | 0.66 | 173 | 152 |
| | 1 | 326 | −27 | 0.87 | 0.61 | 198 | 173 |
| | 2 | 329 | −96 | 0.93 | 0.56 | 183 | 169 |
| | 3 | 269 | −172 | 0.96 | 0.56 | 151 | 145 |
| | 4 | 246 | −198 | 0.95 | 0.60 | 147 | 139 |
| 10 | 0 | 176 | −26 | 0.93 | 0.68 | 121 | 112 |
| | 1 | 194 | −10 | 0.90 | 0.62 | 121 | 109 |
| | 2 | 176 | −20 | 0.91 | 0.63 | 111 | 101 |
| | 3 | 153 | −28 | 0.90 | 0.61 | 94 | 84 |
| | 4 | 119 | −48 | 0.88 | 0.57 | 68 | 60 |
| 15 | 0 | 129 | −16 | 0.87 | 0.61 | 79 | 68 |
| | 1 | 127 | −26 | 0.89 | 0.62 | 79 | 70 |
| | 2 | 119 | −27 | 0.90 | 0.61 | 73 | 65 |
| | 3 | 94 | −38 | 0.90 | 0.61 | 57 | 51 |
| | 4 | 88 | −61 | 0.84 | 0.53 | 46 | 39 |
| 20 | 0 | 124 | −15 | 0.87 | 0.58 | 73 | 63 |
| | 1 | 126 | −17 | 0.88 | 0.61 | 76 | 67 |
| | 2 | 128 | −36 | 0.89 | 0.61 | 78 | 69 |
| | 3 | 89 | −14 | 0.88 | 0.60 | 53 | 46 |
| | 4 | 79 | −54 | 0.83 | 0.51 | 40 | 33 |

### Example 2

### Injeolmi Texture Change According to Different Flour Contents

Texture change of Injeolmi prepared using different flour contents during punching was measured and results thereof are shown in Tables 5 and 6 below, and Table 5 shows results obtained when the water content was 5% in preparing Injeolmi, and Table 6 shows results obtained when the water content was 10%.

In the case that Injeolmi was produced using 5% of the water content, hardness, gumminess, and chewiness were degraded as the flour content was increased within a range of 0 to 1%, and springiness, and cohesiveness were not different from each other. When flour was not added, adhesion was the lowest and hardness was the highest compared to other groups according to storage duration, and thus, it was confirmed that retrogradation of rice cake occurred more quickly than other groups. Also, when flour was added in an amount of 0.1 to 0.2 wt %, retrogradation of rice cake did not occur until the fourth day after production. However, when the flour content was 0.15 wt % or more, overall preference was low. Injeolmi that was produced using 10% of water showed similar properties as those of Injeolmi produced using 5% of water. Accordingly, it was confirmed that when Injeolmi is distributed at room temperature, the addition of 0.08 to 0.12 wt % of flour during the punching contributes to a decrease in retrogradation of Injeolmi while quality thereof is retained.

TABLE 5
Texture analysis according to flour content when Injeolmi was stored at a temperature of 20° C.
(water content of 5%)

| Flour content | Storage duration | | | | | | |
|---|---|---|---|---|---|---|---|
| (%) | (day) | Hardness | Adhesion | Springiness | Cohesiveness | Gumminess | Chewiness |
| 0 | 0 | 297 | −31 | 0.91 | 0.68 | 202 | 184 |
| | 1 | 373 | −105 | 0.93 | 0.59 | 219 | 204 |
| | 2 | 884 | −1013 | 0.91 | 0.49 | 434 | 408 |
| | 3 | 1763 | −3676 | 0.96 | 0.57 | 1013 | 973 |
| | 4 | 2835 | −3923 | 0.97 | 0.55 | 1566 | 1520 |
| 0.05 | 0 | 292 | −38 | 0.88 | 0.66 | 193 | 170 |
| | 1 | 312 | −86 | 0.94 | 0.61 | 190 | 179 |
| | 2 | 575 | −593 | 0.88 | 0.48 | 273 | 245 |
| | 3 | 842 | −1696 | 0.99 | 0.56 | 470 | 465 |
| | 4 | 1333 | −2840 | 1.00 | 0.55 | 730 | 730 |
| 0.10 | 0 | 224 | −31 | 0.91 | 0.66 | 148 | 134 |
| | 1 | 270 | −53 | 0.93 | 0.60 | 163 | 150 |
| | 2 | 454 | −138 | 0.92 | 0.58 | 262 | 241 |
| | 3 | 434 | −476 | 0.96 | 0.55 | 239 | 228 |
| | 4 | 402 | −549 | 0.96 | 0.53 | 213 | 204 |
| 0.15 | 0 | 254 | −28 | 0.89 | 0.64 | 163 | 144 |
| | 1 | 278 | −76 | 0.93 | 0.60 | 167 | 154 |
| | 2 | 390 | −131 | 0.91 | 0.58 | 225 | 205 |
| | 3 | 313 | −216 | 0.95 | 0.59 | 184 | 174 |
| | 4 | 462 | −619 | 0.95 | 0.59 | 266 | 253 |
| 0.20 | 0 | 249 | −28 | 0.91 | 0.68 | 168 | 153 |
| | 1 | 275 | −58 | 0.90 | 0.62 | 171 | 154 |
| | 2 | 376 | −70 | 0.92 | 0.61 | 229 | 210 |
| | 3 | 343 | −147 | 0.95 | 0.57 | 195 | 185 |
| | 4 | 319 | −236 | 0.93 | 0.58 | 187 | 174 |

TABLE 6
Texture analysis according to flour content when Injeolmi was stored at a temperature of 20° C.
(water content of 10%)

| Flour content | Storage duration | | | | | | |
|---|---|---|---|---|---|---|---|
| (%) | (day) | Hardness | Adhesion | Springiness | Cohesiveness | Gumminess | Chewiness |
| 0 | 0 | 174 | −19 | 0.86 | 0.62 | 107 | 93 |
| | 1 | 209 | −22 | 0.90 | 0.60 | 125 | 112 |
| | 2 | 273 | −122 | 0.84 | 0.47 | 129 | 110 |
| | 3 | 660 | −923 | 0.94 | 0.53 | 347 | 326 |
| | 4 | 1471 | −1844 | 0.95 | 0.57 | 839 | 801 |
| 0.05 | 0 | 192 | −18 | 0.87 | 0.62 | 119 | 103 |
| | 1 | 189 | −14 | 0.91 | 0.63 | 119 | 107 |
| | 2 | 210 | −49 | 0.92 | 0.56 | 118 | 108 |
| | 3 | 219 | −170 | 0.88 | 0.55 | 120 | 106 |
| | 4 | 313 | −451 | 0.93 | 0.55 | 171 | 159 |
| 0.10 | 0 | 142 | −18 | 0.88 | 0.59 | 83 | 73 |
| | 1 | 142 | −16 | 0.90 | 0.63 | 90 | 81 |
| | 2 | 137 | −30 | 0.91 | 0.59 | 81 | 74 |
| | 3 | 139 | −32 | 0.89 | 0.60 | 84 | 74 |
| | 4 | 132 | −70 | 0.92 | 0.60 | 79 | 72 |
| 0.15 | 0 | 162 | −26 | 0.89 | 0.61 | 99 | 88 |
| | 1 | 169 | −13 | 0.90 | 0.63 | 107 | 96 |
| | 2 | 139 | −32 | 0.92 | 0.59 | 82 | 75 |
| | 3 | 148 | −45 | 0.92 | 0.57 | 84 | 77 |
| | 4 | 140 | −79 | 0.90 | 0.55 | 77 | 69 |
| 0.20 | 0 | 109 | −16 | 0.84 | 0.57 | 63 | 53 |
| | 1 | 108 | −6 | 0.89 | 0.64 | 69 | 62 |
| | 2 | 86 | −25 | 0.90 | 0.59 | 51 | 46 |
| | 3 | 93 | −17 | 0.89 | 0.58 | 55 | 49 |
| | 4 | 97 | −66 | 0.86 | 0.56 | 55 | 47 |

### Example 3

### Injeolmi Texture Change when Extruding was Further Performed

The extruding was additionally performed to grind grains of rice remaining in the dough using a strong pressure applied by an inner screw when the punched rice cake dough was passed once through a bar rice cake molder. Injeolmi was prepared with different four contents by using a rice cake production method that further includes extruding, and textures thereof were measured. This was performed to confirm a merchantable quality improvement effects (FIG. 3). As a result, the higher the flour content, Injeolmi had poorer hardness and chewiness and better adhesion and springiness. In consideration of a merchantable quality of rice cake, 0 to 0.05 wt % of flour-added groups in which retrogradation had already occurred on the third and fourth days of storage were excluded, and it was confirmed that a flour content that is effective for maintaining a quality of Injeolmi and minimizing hardness is in a range of 0.08 to 0.2 wt %.

### Example 4

### Frozen Injeolmi Texture Change According to Different Flour Contents and Thawing Conditions

Frozen Injeolmi were prepared with different flour contents and texture changes thereof according to thawing conditions are shown in Table 7. When Injeolmi was frozen for 24 hours and then thawed at temperatures of 4° C. and 20° C., the frozen Injeolmi that was produced using 0.5 wt % of flour and thawed at a temperature of 4° C. was hardened according to storage duration. However, in the case of the frozen Injeolmi that was produced using 0.7 wt % of flour, when the thawing temperature was 4° C. and 20° C., retrogradation of Injeolmi was delayed. Accordingly, it was confirmed that 0.55 to 0.8 wt % of flour produces the most appropriate effect for frozen and cold distribution.

TABLE 7
Analysis on frozen Injeolmi texture according to flour content and thawing conditions

| Storage | Flour | Storage | | | | | | |
|---|---|---|---|---|---|---|---|---|
| temperature | content | Duration | | | | | | |
| (° C.) | (%) | (day) | Hardness | Adhesion | Springiness | Cohesiveness | Gumminess | Chewiness |
| 4 | 0.5 | 0 | 247 | −14 | 0.83 | 0.69 | 169 | 141 |
| | | 1 | 549 | −255 | 0.94 | 0.53 | 293 | 275 |
| | | 2 | 852 | −1886 | 0.96 | 0.58 | 494 | 475 |
| | | 3 | 1342 | −2090 | 0.99 | 0.56 | 749 | 741 |
| | 0.7 | 0 | 234 | −16 | 0.86 | 0.66 | 155 | 133 |
| | | 1 | 389 | −83 | 0.89 | 0.60 | 235 | 208 |
| | | 2 | 368 | −731 | 0.92 | 0.52 | 193 | 178 |
| | | 3 | 538 | −794 | 0.87 | 0.53 | 287 | 253 |
| 20 | 0.5 | 0 | 247 | −14 | 0.83 | 0.69 | 169 | 141 |
| | | 1 | 282 | −57 | 0.86 | 0.62 | 174 | 150 |
| | | 2 | 222 | −180 | 0.90 | 0.50 | 109 | 97 |
| | | 3 | 193 | −153 | 0.90 | 0.53 | 101 | 91 |
| | 0.7 | 0 | 234 | −16 | 0.86 | 0.66 | 155 | 133 |
| | | 1 | 248 | −33 | 0.88 | 0.65 | 162 | 142 |
| | | 2 | 224 | −34 | 0.91 | 0.57 | 127 | 116 |
| | | 3 | 222 | −57 | 0.91 | 0.54 | 120 | 109 |

### Example 5

### Frozen Injeolmi Texture Change According to Grinding and Thawing Temperature

Texture change according to grinding of waxy rice before the first steaming and a thawing temperature after the frozen Injeolmi was produced was measured, and results thereof are shown in Table 8. When grinding was additionally performed, gelatinization was performed well during steaming and thus, hardness and chewiness were low, and texture during storage was similar in both cases. However, Injeolmi that was thawed at a temperature of 20° C. and stored had lower hardness than Injeolmi that was thawed at a temperature of 4° C. and stored.

TABLE 8
Analysis on frozen Injeolmi texture according to grinding and thawing temperature

| Storage | | Storage | | | | | | |
|---|---|---|---|---|---|---|---|---|
| temperature | | Duration | | | | | | |
| (° C.) | Grinding | (day) | Hardness | Adhesion | Springiness | Cohesiveness | Gumminess | Chewiness |
| 4 | No | 0 | 219 | −20 | 0.88 | 0.69 | 150 | 133 |
| | | 1 | 257 | −65 | 0.95 | 0.61 | 157 | 148 |
| | | 2 | 296 | −151 | 0.93 | 0.56 | 165 | 153 |
| | | 3 | 277 | −364 | 0.91 | 0.51 | 142 | 129 |
| | Yes | 0 | 210 | −20 | 0.87 | 0.70 | 146 | 126 |
| | | 1 | 246 | −59 | 0.93 | 0.63 | 154 | 144 |
| | | 2 | 228 | −128 | 0.94 | 0.58 | 131 | 123 |
| | | 3 | 249 | −428 | 0.89 | 0.52 | 128 | 115 |
| 20 | No | 0 | 219 | −20 | 0.88 | 0.69 | 150 | 132.81 |
| | | 1 | 150 | −31 | 0.93 | 0.63 | 95 | 88.39 |
| | | 2 | 128 | −32 | 0.92 | 0.62 | 79 | 72.98 |
| | | 3 | 131 | −58 | 0.90 | 0.58 | 76 | 68.45 |
| | Yes | 0 | 210 | −20 | 0.87 | 0.70 | 146 | 125.85 |
| | | 1 | 161 | −35 | 0.93 | 0.64 | 103 | 95.53 |
| | | 2 | 141 | −27 | 0.92 | 0.63 | 88 | 81.27 |
| | | 3 | 134 | −61 | 0.89 | 0.61 | 82 | 73.45 |

### Example 6

### Frozen Injeolmi Texture Change According to Repetition of Freezing and Thawing

Frozen Injeolmi was produced in the same manner as in Preparation Example 5, except that the flour content was in a range of 0.55 to 0.7% based on the weight of the water-soaked waxy rice. The produced Injeolmi was frozen for 24 hours, and then thawed at a temperature of 4° C. for 24 hours. This freezing and thawing cycle was performed three times. The resultant texture change according to the cycle number was measured and results thereof are shown in Table 9. As a result, Injeolmi that was subjected to the freezing and thawing cycle had better hardness, springiness, gumminess, and chewiness than Injeolmi that was not subjected to the freezing and thawing cycle. However, the texture was not changed according to the number of the freezing and thawing cycle. Although there was a big difference in adhesion, on appearance, dividing or bursting did no occur. Accordingly, it was confirmed that the storage and distribution conditions in which freezing and thawing are repeatedly performed, do not affect a quality of Injeolmi.

TABLE 9
Analysis on frozen Injeolmi texture according to freezing and thawing cycle

| Number of freezing and | | | | | | |
|---|---|---|---|---|---|---|
| thawing cycle (count) | Hardness | Adhesion | Springiness | Cohesiveness | Gumminess | Chewiness |
| 0 | 165 | −16 | 0.86 | 0.68 | 112 | 95 |
| 1 | 331 | −81 | 0.93 | 0.60 | 198 | 184 |
| 2 | 365 | −330 | 0.92 | 0.49 | 180 | 167 |
| 3 | 351 | −569 | 0.93 | 0.51 | 179 | 167 |

It should be understood that the exemplary embodiments described therein should be considered in a descriptive sense only and not for purposes of limitation. Descriptions of features or aspects within each embodiment should typically be considered as available for other similar features or aspects in other embodiments.

1. A method of producing a waxy rice cake, the method comprising:
(a) immersing waxy rice in water and removing the water therefrom;
(b) first steaming the waxy rice from which water is removed;
(c) adding salt and water to the first steamed waxy rice, followed by second steaming; and
(d) cooling the second steamed waxy rice and adding a flour thereto, followed by punching.

2. The method of claim 1, wherein the method further comprises grinding before the waxy rice from which water is removed in process (b) is first-steamed.

3. The method of claim 1, wherein the method further comprises (e) extruding the punched rice cake.

4. The method of claim 1, wherein based on the waxy rice in process (a), an amount of the water in process (c) is in a range of 2 to 20 wt %.

5. The method of claim 1, wherein based on the waxy rice in process (a), an amount of the flour in process (d) is in a range of 0.08 to 1.0 wt %.

6. The method of claim 1, wherein the punching in process (d) is performed for 3 to 20 minutes.

7. The method of claim 1, wherein a cooling temperature of the second steamed waxy rice in process (d) is in a range of 51 to 79° C.

8. The method of claim 1, wherein an amount of the water in process (c) is in a range of 4 to 15 wt % based on the amount of the waxy rice in process (a).

9. The method of claim 1, wherein an amount of the flour in process (d) is in a range of 0.1 to 0.7 wt % based on the amount of the waxy rice in process (a).

10. The method of claim 1, wherein the punching in process (d) is performed for 7 to 15 minutes.

11. The method of claim 1, wherein a cooling temperature of the second steamed waxy rice in process (d) is in a range of 61 to 69° C.

12. A waxy rice cake produced by using the method of claim 1.

13. The waxy rice cake of claim 12, wherein the waxy rice cake is Injeolmi, a mugwort Injeolmi, a marriage Injeolmi, a red bean Injeolmi, a flower Injeolmi, a glutinous millet Injeolmi, a small straw bag-shaped rice cake, a cake flavored with pine endodermis, a sticky nutrient rice cake, or a Danja.

14. A processed food produced by processing the waxy rice cake of claim 12.
